(19) United States
(12) Patent Application Publication
(10) Pub. No.: US 2026/0344700 A1
(43) Pub. Date: Nov. 5, 2026

(54) MEAT ANALOGUE COMPOSITION

(71) Applicant: Cargill, Incorporated, Wayzata, MN (US)

(72) Inventors: Zuzana Van Beveren, Hombeek (BE); Pablo Zatarain Hernandez, Gembloux (BE)

(73) Assignee: Cargill, Incorporated, Wayzata, MN (US)

(21) Appl. No.: 19/486,481

(22) PCT Filed: May 31, 2024
(86) PCT No.: PCT/US2024/031819

§ 371 Date: Nov. 21, 2025

(30) Foreign Application Priority Data
May 31, 2023 (EP) 23176572.8

(51) Int. Cl. A23J 3/14; A23L 33/115

(52) U.S. Cl. CPC A23J 3/14; A23L 33/115

(57) ABSTRACT

The present invention relates to a composition comprising pea protein and corn protein. In particular, the present invention relates to a composition comprising pea protein and corn protein for use in a meat analogue food product. The present invention also relates to a composition as an emulsion comprising pea protein, corn protein, oil and water and a method of making the composition as an emulsion. In particular, the present invention relates to a composition as an emulsion comprising pea protein, corn protein, oil and water for use in a meat analogue food product.

### CROSS REFERENCE TO RELATED APPLICATIONS

This application claims the benefit of European Application No. 23176572.8, filed May 31, 2023, which is incorporated by reference herein in its entirety.

### FIELD OF THE INVENTION

The present invention relates to a composition comprising pea protein and corn protein. In particular, the present invention relates to a composition comprising pea protein and corn protein for use in a meat analogue food product, preferably for use in an emulsified meat analogue food product. The present invention also relates to a composition as an emulsion comprising pea protein, corn protein, oil and water and a method of making the composition as an emulsion. In particular, the present invention relates to a composition as an emulsion comprising pea protein, corn protein, oil and water for use in a meat analogue food product. Preferably, the pea protein and corn protein are both isolates.

### BACKGROUND OF THE INVENTION

A meat analogue food product is a food product produced from vegetarian or vegan ingredients. The meat analogue food product may be eaten as a replacement for meat. There is an ever-increasing demand for meat analogue food products owing to growing concerns on the environmental impact from meat production as well as growing concerns on a consumer's personal health from eating food products sourced from animals.

The development of meat analogue food products has less of a negative impact on the environmental compared to food products sourced from animals. For example, the manufacture of meat analogue food products produces less greenhouse gases compared to the amount of greenhouse gases produced in meat production. As a second example, the manufacture of meat analogue food products also requires less water and less land compared to the amount of water and land required to produce food products sourced from animals.

Further advantageously, the development of meat analogue food products has a positive impact on a person's health owing to meat analogue food products being able to reduce the risk of heart disease, strokes or diabetes.

There are many different types of meat analogue food products available on the market. The most common types of meat analogue food products are based upon rice, mushrooms, legumes, tempeh, seitan, yam flour or pressed tofu. Typically, the meat analogue food product includes flavourings to make the meat analogue food product taste like chicken, beef, lamb, ham, sausage or seafood.

Whilst meat analogue products have been readily available to consumers for a number of years, in recent years consumers have begun to have a higher expectation on meat analogue products. In particular, consumers expect meat analogue products to give a similar culinary and eating experience. The consumer expects the meat analogue product to have similar, if not the same, visual, texture and taste characteristics as a product sourced from an animal. There is therefore a need for an improved meat analogue food product. In particular, there is a need for an improved meat analogue food product that has similar, if not the same, visual, texture and taste characteristics as a product sourced from an animal.

In particular, there is a need for an improved emulsified meat analogue food product that has similar, if not the same, visual, texture and taste characteristics as an emulsified product sourced from an animal, for instance hotdogs.

In particular, there is a need for an improved emulsified meat analogue food product that has similar, if not the same, visual, texture and taste characteristics as an emulsified product sourced from an animal, for instance hotdogs, and also improved dough properties that make it easier to handle and/or that make it easier to fill for instance into hotdog casings.

In particular, there is a need for an improved emulsified meat analogue food product that has similar, if not the same, visual, texture and taste characteristics as an emulsified product sourced from an animal, for instance hotdogs, and also improved freeze/thaw stability, so that the food product can also be stored in a freezer without affecting its sensory profile upon consumption.

### SUMMARY OF THE INVENTION

The present invention relates to a composition comprising pea protein and corn protein. In particular, the present invention relates to a composition comprising pea protein and corn protein for use in a meat analogue food product, preferably for use in an emulsified meat analogue food product. The present invention also relates to a composition as an emulsion comprising pea protein, corn protein, oil and water and a method of making the composition as an emulsion. In particular, the present invention relates to a composition as an emulsion comprising pea protein, corn protein, oil and water for use in a meat analogue food product, preferably for use in an emulsified meat analogue food product.

Representative features of the present invention are set out in the following clauses, which stand alone or may be combined, in any combination, with one or more features disclosed in the text and/or figures of the specification.

The present invention is as set out in the following clauses:

1. A composition comprising:
a pea protein; and
a corn protein.
   2. The composition of clause 1, wherein the composition comprises the pea protein and corn protein at a ratio of from 20:80 to 80:20 respectively, or, at a ratio of from 60:40 to 40:60 respectively, or, at a ratio of from 80:20 to 40:60 respectively, or, at a ratio of 50:50 respectively.
   3. The composition of clause 1 or clause 2, wherein the pea protein is an (preferably non-hydrolyzed) isolate, preferably comprising at least 70 wt % of protein.
   4. The composition of any one of clauses 1 to 3, wherein the corn protein is an (preferably non-hydrolyzed) isolate, preferably comprising at least 75 wt % of protein.
   5. The composition of any one of clauses 1 to 4, wherein the composition is an emulsion and further comprises:
water; and
oil.
   6. The composition of clause 5, wherein the corn protein and pea protein combined, the water and the oil are present at a ratio of from 1:1:1 to 1:10:20, or, from 1:2:2 to 1:8:16, or, from 1:3:3 to 1:6:12, or, 1:3:3, or, 1:5:5, or, 1:6:12 respectively.
   7. The composition of clause 5 or clause 6, wherein the composition further comprises one or more of texturising and stabilising systems, sugars, starches, salt, colourants, flavourings and/or any combination thereof.
   8. A method of making the composition of any one of clauses 5 to 7 or any one of clauses 1 to 4, wherein the method comprises the steps of:
(a) providing a pea protein;
(b) providing water;
(c) combining the pea protein and water to form a hydrated pea protein;
(d) providing a corn protein;
(e) combining the corn protein with the hydrated pea protein to form a mixture; (f) providing an oil; and
(g) combining the oil with the mixture until an emulsion is formed.
   9. The method of clause 8, wherein the steps (a) to (g) are carried out in the order of (a), (b), (c), (d), (e), (f) and then (g).
   10. The method of clause 8 or clause 9, wherein the water is at a temperature of from 0.1 to 10 °C, or, from 0.5 to 7 °C, or, from 1 to 5 °C, or, from 2 to 4 °C.
   11. The method of any one of clauses 8 to 10, wherein the pea protein and water are combined by mixing at a speed of from 100 to 1500 RPM, or, from 250 to 1250 RPM, or, from 500 to 1000 RPM during step (c).
   12. The method of any one of clauses 8 to 11, further comprising the step of combining the pea protein, water, hydrated pea protein and/or corn protein with a texturising and stabilising system, sugar, starch, salt, colourant, flavouring, and/or any combination thereof.
   13. The method of clause 12, wherein the pea protein, water, hydrated pea protein and/or corn protein is/are combined with a texturising and stabilising system, sugar, starch, salt, colourant, flavouring, and/or any combination thereof by mixing at a speed of from 100 to 1500 RPM, or, from 250 to 1250 RPM, or, from 500 to 1000 RPM.
   14. The method of any one of clauses 8 to 13, wherein the corn protein and hydrated pea protein are combined by mixing at a speed of from 500 to 4000 RPM, or, from 750 to 3500 RPM, or, from 1000 to 3000 RPM during step (e).
   15. The method of any one of clauses 8 to 14, wherein the mixture and oil are combined by mixing at a speed of from 4000 to 6000 RPM, or, from 4500 to 6000 RPM, or, from 5000 to 6000 RPM during step (g).
   16. The method of clause 15, wherein step (g) is carried out at least partially under vacuum.
   17. The method of clause 16, wherein step (g) is carried out:
at from 75 to 95% vacuum, or, from 80 to 90% vacuum, or, at 85% vacuum;
for from 60 to 120 seconds, or, from 80 to 100 seconds, or, 90 seconds; and/or,
at a speed of from 5000 to 6000 RPM, or, from 5500 to 6000 RPM, or, at 6000 RPM.
   18. The method of any one of clauses 8 to 17, wherein the method further comprises the following step:
(h) cooking the emulsion to form a cooked food product.
   19. The method of any one of clauses 8 to 13 and clause 18, wherein:
the corn protein is provided in an oil; and
step (e) is carried out until an emulsion is formed; and
steps (f) and (g) are not present.
   20. The method of clause 19, wherein the corn protein is provided as a dispersion in an oil.
   21. A food product obtained, or obtainable, from the method of any one of clauses 8 to 20.
   22. Use of the composition of any one of clauses 1 to 7 to form a plant-based emulsified food product;
optionally, wherein the plant-based emulsified food product is a meat analogue; optionally, wherein the meat analogue is meat-free sausages, meat-free hot dogs, meat-free cold cuts, meat-free frankfurters and/or meat-free sliced deli meats.
   23. Use of the composition of any one of clauses 1 to 7 as a meat extender in the preparation of a partially plant-based, partially meat-derived emulsified food product; optionally, wherein the food product is a sausage, hot dog, cold cuts, frankfurters and/or sliced deli meats.
   24. The composition as disclosed in any of the above clauses, wherein the composition does not comprise substantially any pea flour and/or wherein the composition does not comprise substantially any corn flour and/or wherein the corn protein is not a substantially pure zein protein.

### DETAILED DESCRIPTION

Embodiments of the invention are described below with reference to the accompanying drawings. The accompanying drawings illustrate various embodiments of systems, methods, and embodiments of various other aspects of the disclosure. Any person with ordinary skills in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles.

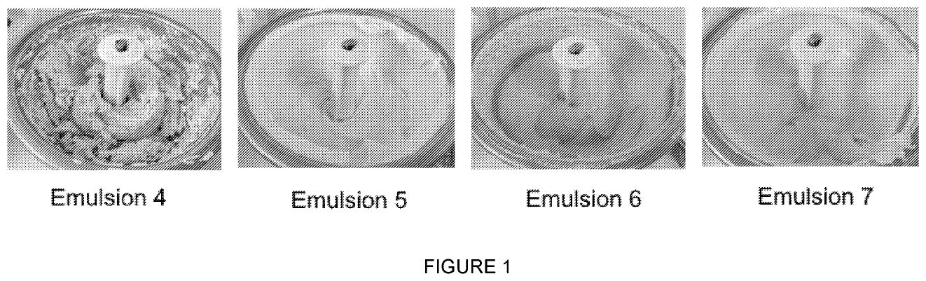

FIG. 1 is images of Emulsion 4, Emulsion 5, Emulsion 6 and Emulsion 7.

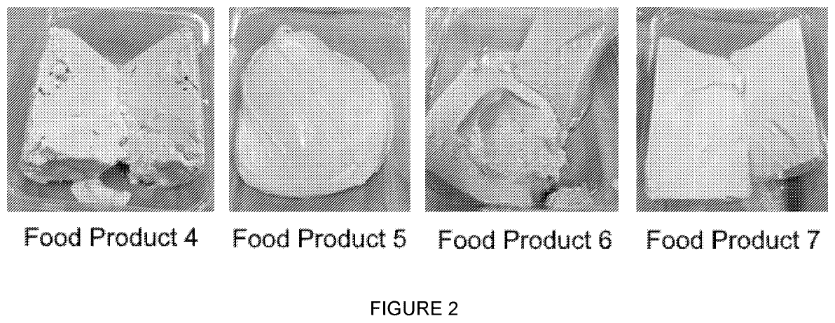

FIG. 2 is images for Food Product 4, Food Product 5, Food Product 6 and Food Product 7.

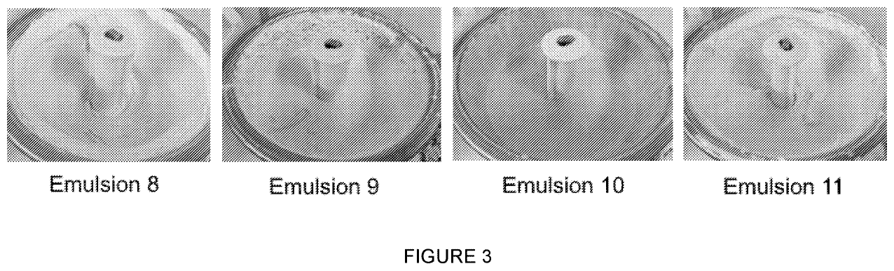

FIG. 3 is images of Emulsion 8, Emulsion 9, Emulsion 10 and Emulsion 11.

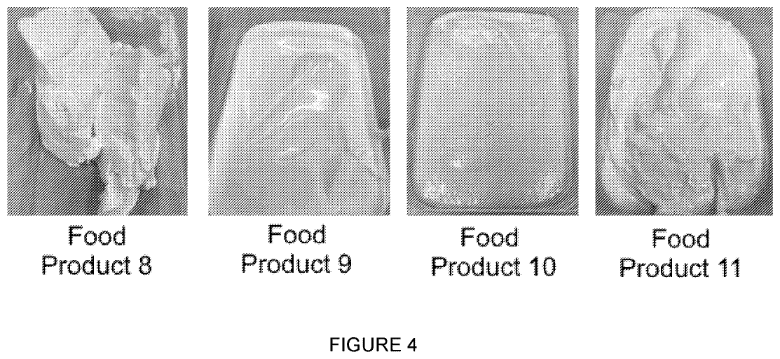

FIG. 4 is images of Food Product 8, Food Product 9, Food Product 10 and Food Product 11.

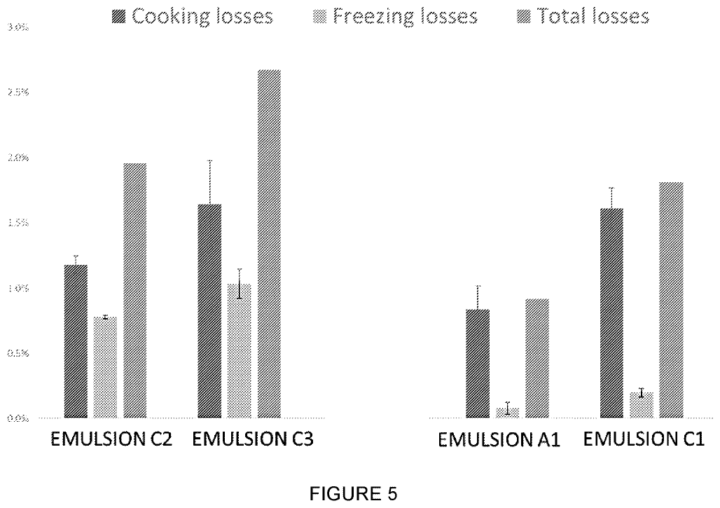

FIG. 5 is graphs of the cooking and freezing losses of various emulsified food products.

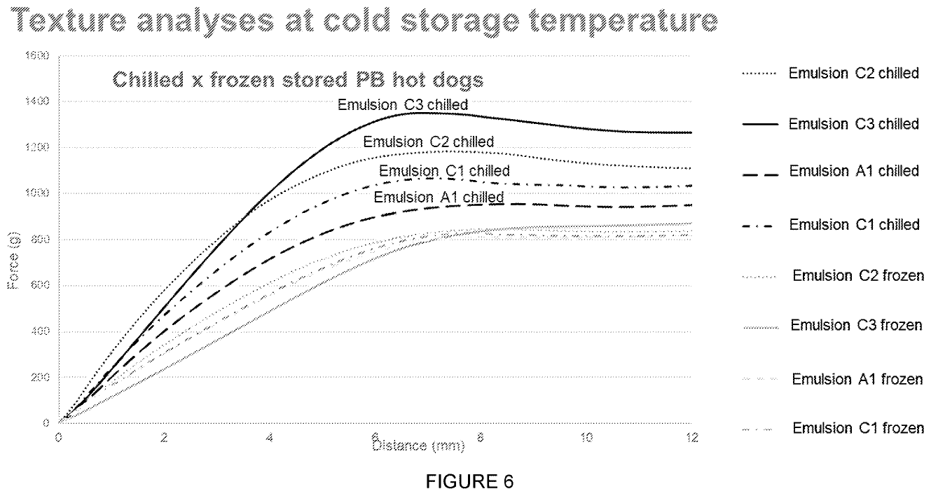

FIG. 6 is a texture analyses at cold storage temperature of various emulsified food products.

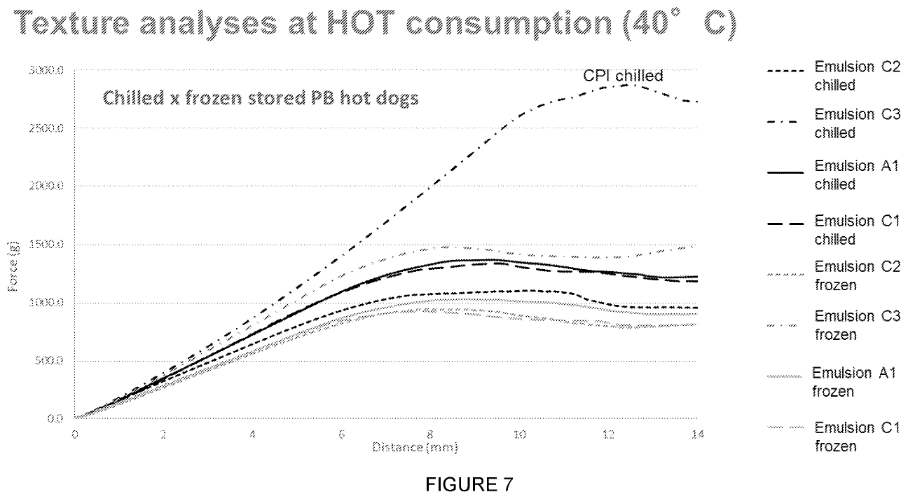

FIG. 7 is a texture analyses at hot consumption temperature of various emulsified food products.

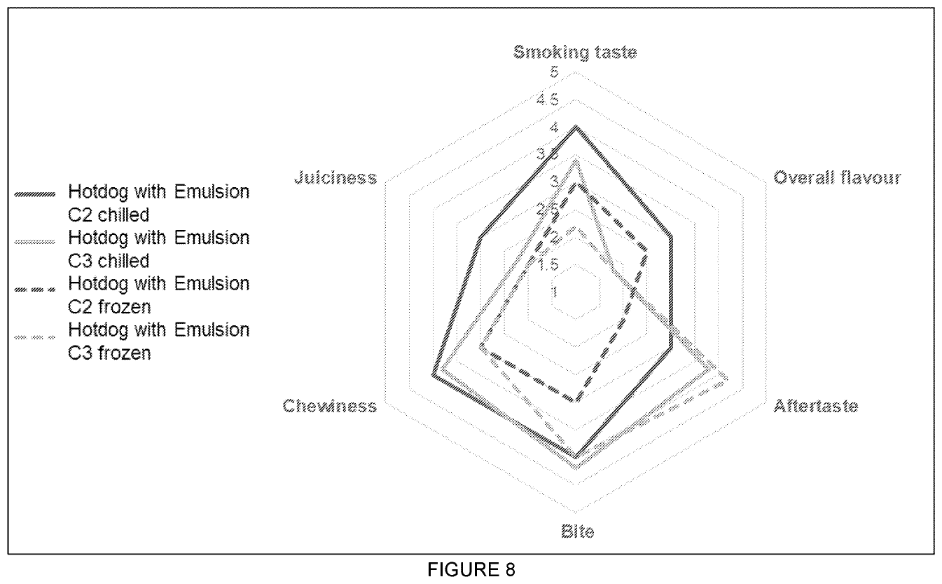

FIG. 8 shows the sensory analysis of various emulsified food products with pea protein or corn protein as the only source of protein.

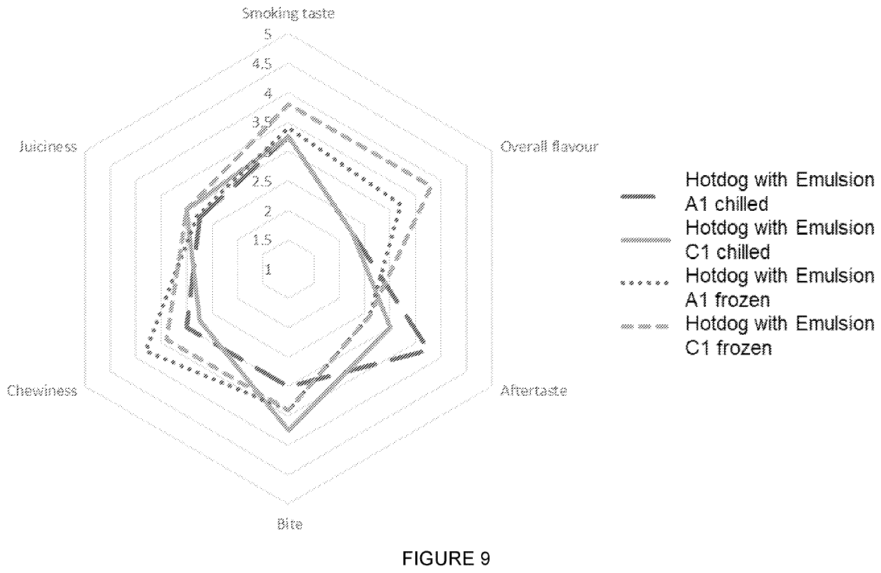

FIG. 9 shows the sensory analysis of various emulsified food products with pea protein AND corn protein added either separately to form the emulsion or together.

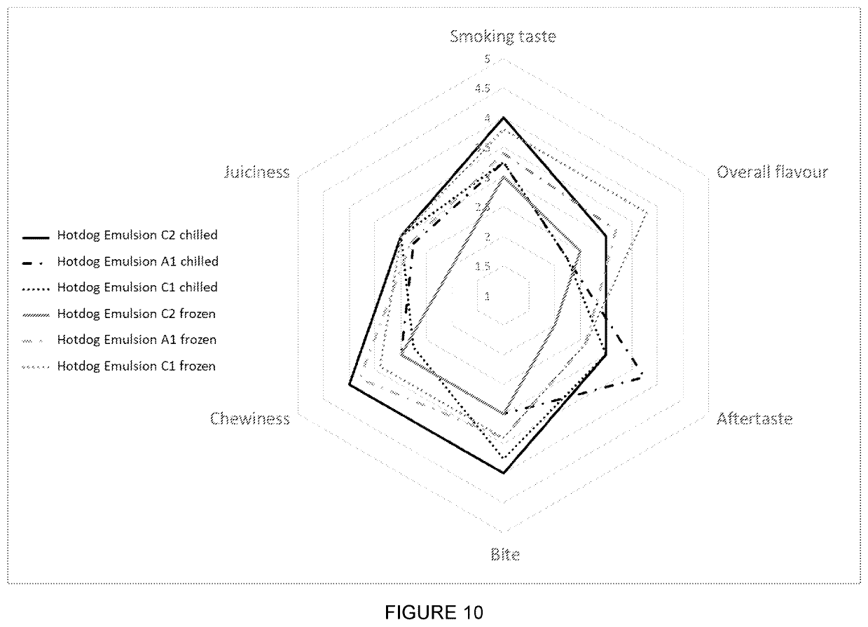

FIG. 10 shows the sensory analysis of various emulsified food products with pea protein AND corn protein added either separately to form the emulsion or together compared with pea protein alone.

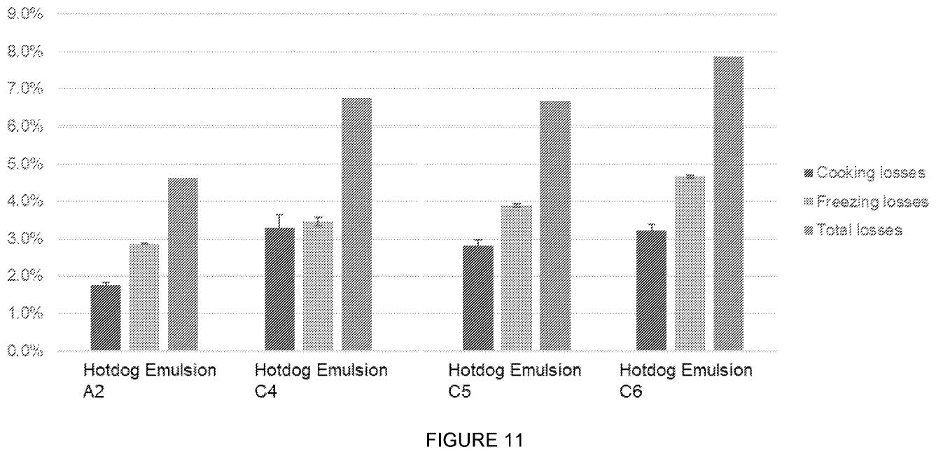

FIG. 11 shows a graph of the cooking and freezing losses for various emulsified food products.

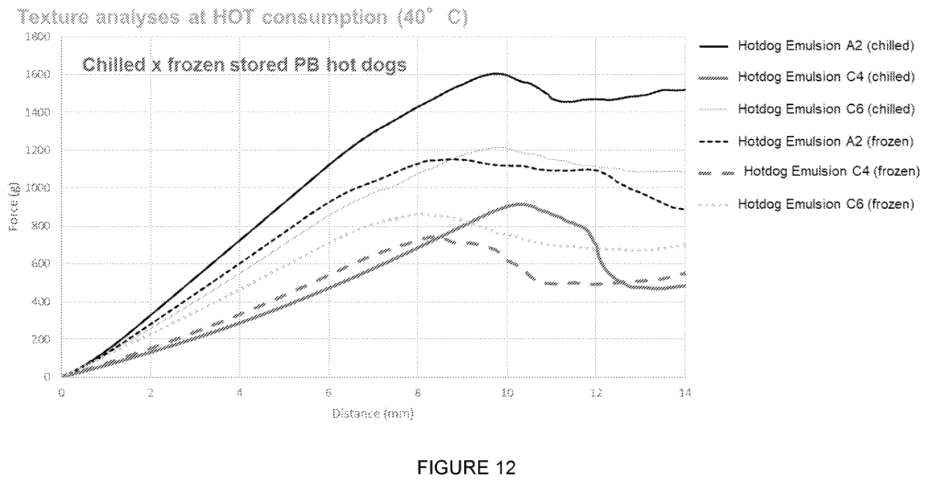

FIG. 12 is a texture analyses at hot consumption temperature for various emulsified food products.

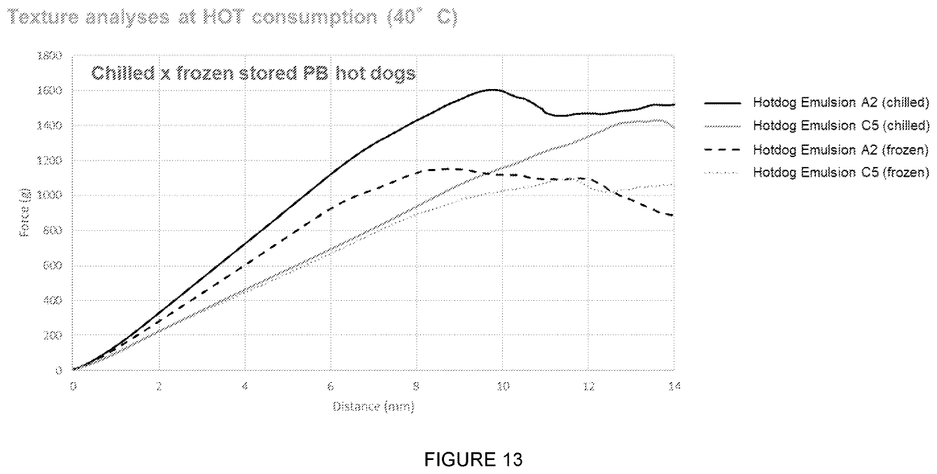

FIG. 13 is a texture analyses at hot consumption temperature for various emulsified products.

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein.

The words “comprising,” “having,” “containing,” and “including,” and other forms thereof, are intended to be equivalent in meaning and be open ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the preferred systems and methods are now described.

Some of the terms used to describe the present invention are set out below:

“Blend” refers to a mix of different components.

“Composition” refers to the combination of at least two components. The composition can be a powder, an emulsion, a solution, a suspension, or a dispersion. Preferably, the composition is a powder or an emulsion. The at least two components can be mixed or blended to form a mix. Alternatively, the at least two components are not mixed or blended and are present as at least two separate components.

“Core temperature” refers to the temperature of the centre of the material under analysis, wherein the centre is the inner, middle part of the material under analysis.

“Cuttable” refers to a food product that can be cut with a knife whilst maintaining its original shape (i.e., not collapsing upon being cut with a knife).

“Dispersion” refers to the distribution of a plant protein within an oil. Preferably, the plant protein is in a powder form and the oil is in a liquid form. The plant protein may be a corn protein. For example, a dispersion may be a corn protein (in powder form) within an oil (in liquid form). Other ingredients may be present in the powder, such as but not limited to, texturising and stabilising systems, sugars, salts, colourants and/or flavourings.

“Gelled” refers to a food product that contains water captured in a three-dimensional matrix of plant proteins.

“Heat-treated” refers to the subjection of a material to heat, for example, but not limited to, cooking a material.

“Isolate” refers to a protein that has undergone processing to separate and collect the purest protein fractions, thereby removing/reducing any potentially unwanted material. Possible unwanted materials include fats, lactose, fibers, starches and other impurities.

“Meat analogue food product” refers to a food product produced from vegetarian or vegan ingredients only. The meat analogue food product may be eaten as a replacement for meat.

“Mix” or “mixture” refers to a substance containing two or more different components, whereas the term “mixed” refers to a method step wherein a mix or mixture is formed.

“Non-hydrolysed” refers to a protein that has not undergone hydrolysis or been exposed to a hydrolysing step.

“Plant-based emulsified food product” refers to a food product that may be an emulsion and is produced from vegetarian or vegan ingredients only. The plant-based emulsified food product may be eaten as a replacement for meat. Plant-based emulsified food products include, but are not limited to, food products that use plant-based protein as a source of protein to replace meat.

“Vegan” refers to a product which is not derived from animals.

“Vegetarian” refers to a product which is not derived from meat, where meat includes, but is not limited to, red meat such as beef and pork meat, poultry, seafood and insects.

### Composition

Compositions according to the presently described invention have various desirable properties, which make these compositions useful in a meat analogue food product.

The composition comprises a pea protein and a corn protein. Preferably, the composition is a powder wherein the pea protein and corn protein are both powders. Preferably, the pea protein is not present as part of pea flour. Preferably, the pea protein comprises at least 70 weight % protein of the total weight of the pea protein, more preferably at least 75 weight % protein of the total weight of the pea protein, most preferably at least 80 weight % protein of the total weight of the pea protein. Preferably, the pea protein comprises at most 30 weight %, preferably at most 25 weight %, or preferably at most 20 weight % starches, fibres and lipids of the total weight of the pea protein. Preferably, the corn protein is not present as zein protein alone. Preferably, the corn protein is not present as part of corn flour. Preferably, the corn protein comprises at least 75 weight % protein of the total weight of the corn protein, more preferably at least 80 weight % protein of the total weight of the corn protein, most preferably at least 85 weight % protein of the total weight of the corn protein. Preferably, the corn protein comprises at most 25 weight %, preferably at most 20 weight %, or preferably at most 15 weight % starches, fibres and lipids of the total weight of the corn protein.

Preferably, the pea protein comprises at least 80 weight % protein of the total weight of the pea protein and the corn protein comprises at least 85 weight % protein of the total weight of the corn protein.

The pea protein may be sourced from legumes by the method set out in US2021/0401022 A1 and/or any method well-known in the art. The disclosures of the listed patents/patent applications are incorporated by reference in their entirety.

The corn protein may be sourced from corn by the method set out in PCT/US2017/023988 (publication number WO2017/165748), PT/US2017/055498 (publication number WO2018/058150), PCT/US2018/038541 (publication number WO2018/237030), PCT/US2018/045029 (publication number WO2019/028263), PCT/US2018/050447 (publication number WO/2019/060179), PCT/US2018/052153 (publication number WO2019/060673), PCT/US2017/023999 (publication number WO2017/165756), PCT/US2016/024020 (WO2016/154441) and/or PCT/US2019/059482 (publication number WO2020/092964) and/or any method well-known in the art. The disclosures of the listed patents/patent applications are incorporated by reference in their entirety.

Preferably, the pea protein in the composition is non-hydrolysed.

Preferably, the pea protein in the composition is an isolate. Examples of (non-hydrolysed) pea protein isolate are Puris™ Pea 870 & RadiPure® S. Preferably, the pea protein isolate comprises at least 75 weight % protein of the total weight of the pea protein isolate, more preferably at least 80 weight % protein of the total weight of the pea protein isolate, most preferably at least 85 weight % protein of the total weight of the pea protein isolate. Preferably, the pea protein isolate comprises at most 25 weight %, preferably at most 20 weight %, or preferably at most 15 weight % starches, fibres and lipids of the total weight of the pea protein isolate.

Preferably, the corn protein in the composition is non-hydrolysed.

Preferably, the corn protein in the composition is an isolate (also referred to herein as “CPI”). The (non-hydrolysed) corn protein isolate (“CPI”) can be prepared according to one or more of the methods set out in PCT/US2017/023988 (WO2017/165748), PT/US2017/055498 (WO2018/058150), PCT/US2018/038541 (WO2018/237030), PCT/US2018/045029 (WO2019/028263), PCT/US2018/050447 (WO/2019/060179), and/or PCT/US2016/024020 (WO2016/154441), which are incorporated herein by reference in their entirety. Preferably, the CPI comprises at least 75 weight or at least 80 weight % protein of the total weight of the CPI, more preferably at least 85 weight % protein of the total weight of the CPI. Preferably, the CPI comprises at most 25 weight % or at most 20 weight %, preferably at most 15 weight % starches, fibres and lipids of the total weight of the CPI. The CPI includes an “a*” colour value ranging from about −2.5 to about 1.5, and a “b*” colour value ranging from about 5 to about 25. The CPI comprises both zein proteins and non-zein corn proteins. Non-zein corn proteins comprise for instance glutelins. The CPI has at most 70 wt % of zein protein based on the total protein content of the CPI on a dry weight basis as measured according to the Osborn fractionation method (R.

H. CHITTENDEN AND T. B. OSBORNE. A Study of the Proteids of the Corn or Maize Kernel, Amer. Chem. J., 1891, 13, 453-468, 529-552, and 1892, 14, 20-44)] well-known to a person skilled in the art.

The CPI can be less than about 1.5 wt % oil on a dry basis (e.g., not including the one or more fats added to the CPI to form the emulsified meat analogue food product, such as measured prior to combination of the CPI with the oil in the emulsified meat analogue food product), less than 1 wt % oil on a dry basis, or less than about 0.5 wt % oil on a dry basis, or less than about 1.5 wt %, 1.4, 1.3, 1.2, 1.1, 1, 0.9, 0.8, 0.7, 0.6, 0.5, 0.4, 0.3, or less than about 0.2 wt % oil on a dry basis.

Corn protein can be any suitable proportion of the CPI, such as 85 wt % of the CPI or more on a dry basis, or about 87 wt % to about 98 wt % of the CPI on a dry basis, or about 87 wt % to about 92 wt % of the CPI on a dry basis, or less than or equal to about 98 wt % and greater than or equal to about 85 wt %, 86, 87, 88, 89, 90, 91, 92, 93, 94, 95, 96, or 97 wt % on a dry basis.

The CPI can have any suitable L* colour value. For example, the CPI can have an L* colour value of at least 88, or of about 88 to about 95, or from about 90 to about 92, or less than or equal to 95 and greater than or equal to about 88, 89, 90, 91, 92, 93, or 94. The CPI can have any suitable “a*” colour value, such as an a* colour value of about −2.5 to about 1.5, −2.5 to −0.5, —2 to −1, −0.3 to 0.3, −0.2 to 0.2, or less than or equal to about 1.5 and greater than or equal to about −2.5, −2.4, −2.3, −2.2, −2.1, −2, −1.9, −1.8, −1.7, −1.6, −1.5, −1.4, −1.3, −1.2, −1.1, −1, −0.9, −0.8, −0.7, −0.6, −0.5, −0.4, −0.3, −0.2, −0.1, 0, 0.1, 0.2, 0.3, 0.4, 0.5, 0.6, 0.7, 0.8, 0.9, 1, 1.1, 1.2, 1.3, or 1.4. The CPI can have any suitable “b*” colour value, such as about 5 to about 25, about 1.0 to about 20, from about 10 to about 15, or less than or equal to 25 and greater than or equal to 5, 6, 7, 8, 9, 10, 11, 12, 13, 14, 15, 16, 17, 18, 19, 20, 21, 22, 23, or 24. The L* value, “a*” value, and “b*” colour values can be measured using a colourimeter, in particular colour values can be measured using a HunterLab Colorimeter (Model CFE2, Hunter Associates Laboratory, Inc., Reston, VA). The instrument reads out in the Hunter L*, “a*”, “b*” scale where the L* value is an indication of color lightness (the higher the value, the light er/whiter the product). Hunter “a*” represents the red-green color spectrum with a positive value indicating a red hue. Hunter “b*” represents the yellow-blue spectrum with a positive value indicating a yellow hue. All measurements are made on dry powders.

The CPI can have any suitable soluble carbohydrate concentration, such as a soluble carbohydrate concentration of 40 g/kg or less, or 25 g/kg or less, or equal to or less than about 40 g/kg, 38, 36, 34, 32, 30, 28, 26, 24, 22, 20, 18, 16, 14, 12, or 10 g/kg or less.

The CPI can have any suitable organic acid concentration, such as an organic acid concentration of about 4.25 g/kg or less, 3.5 g/kg or less, or 2.0 g/kg or less, or less than or equal to 4.25 g/kg, 4.2 4.1, 3, 3.9, 3.8, 3.7, 3.6, 3.5, 3.4, 3.3, 3.2, 3.1, 3, 2.9, 2.8, 2.7, 2.6, 2.5, 2.4, 2.3, 2.2, 2.1, 2, 1.9, 1.8, 1.7, 1.6, 1.5, 1.4, 1.3, 1.2, 1.1, or 1 g/kg or less.

The CPI can have an aflatoxin concentration of less than about 1 ppb, or less than about 0.5 ppb, or no detectable aflatoxin. AOAC 994.08 can be used to test for aflatoxin.

The CPI can have a free sulfite concentration of less than about 150 ppm, less than about 120 ppm, or less than about 100 ppm, or no detectable free sulfite concentration. Free sulfite can be measured by the Monier-Williams AOAC 990.28 method.

The CPI can have any suitable particle size. For example, the CPI can have a D95 particle size of 5 microns to 40 microns, or 10 microns to 30 microns, or 15 microns to 25 microns, or less than or equal to 40 microns and greater than or equal to 5 microns, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, or 39 microns. The CPI can have a D50 particle size of 1 micron to 30 microns, or 2 microns to 15 microns, or 5 microns to 10 microns, or less than or equal to 30 microns and greater than or equal to 1 micron, 2, 3, 4, 5, 6, 7, 8, 9, 10, 11, 12, 13, 14, 15, 16, 17, 18, 19, 20, 21, 22, 23, 24, 25, 26, 27, 28, or 29 microns.

The CPI can be formed via any suitable process that forms a suitable CPI for the emulsified meat analogue food product of the present invention described herein. For example, the CPI can be formed using a method including providing a wet destarched corn gluten material containing water, and washing the destarched corn gluten material with a water-miscible organic solvent to obtain the CPI. Alternatively, the CPI can be formed using a method including providing a dried destarched corn gluten material, and washing the destarched corn gluten material with a water-miscible organic solvent and water to obtain the CPI. The destarched corn gluten material can include residual insoluble starch solids ranging from about 0.1 to about 3.0 wt % on a dry basis, as measured by Ewers' Polarimetric method ISO 10520:1997. During the washing step, the water-miscible organic solvent can include ethanol, ethyl acetate, isopropanol, or mixtures thereof, and is present in a concentration ranging from about 75 wt % to about 100 wt % based on the total amount of water and water-miscible organic solvent present during washing. Alternatively, the water-miscible organic solvent can be in a concentration ranging from about 85 wt % to about 100 wt %, from about 75 wt % to about 99.9 wt %, or from about 85 wt % to about 99 wt % based on the total amount of water and water-miscible organic solvent present during washing. The amount of water-miscible organic solvent required will depend on the amount of water present in the destarched corn gluten material, if any, and the amount of additional water added, if any. The amount of water-miscible organic solvent and water is optimized to maximize the removal non-protein components, which can include organic acids, carbohydrates, mycotoxins, and oils. The volume of the water-miscible organic solvent can be from about 3 to about 40 liters per kilogram of destarched corn gluten having a moisture content of up to 65 wt %. In some aspects, the corn gluten material starting material can be the corn protein concentrate described in U.S. Pat. No. 9,226,515, hereby incorporated by reference in its entirety. The CPI comprises both zein and non-zein corn proteins. Non-zein corn proteins comprise for instance glutelins. The CPI has at most 70 wt % of zein protein based on the total protein content of the CPI on a dry weight basis as measured according to the Osborn fractionation method (R. H. CHITTENDEN AND T. B. OSBORNE. A Study of the Proteids of the Corn or Maize Kernel, Amer. Chem. J., 1891, 13, 453-468, 529-552, and 1892, 14, 20-44)] well-known to a person skilled in the art.

Preferably, the pea protein in the composition is a non-hydrolysed isolate and the corn protein in the composition is a non-hydrolysed isolate, CPI as described above.

Preferably, the composition comprises from 1 to 30 weight % of pea protein and corn protein of the total weight of the composition, more preferably from 2 to 24 weight % of pea protein and corn protein of the total weight of the composition, even more preferably from 4 to 20 weight % of pea protein and corn protein of the total weight of the composition, even more preferably from 5 to 19 weight %, most preferably from 5.25 to 18.0 weight % of pea protein and corn protein of the total weight of the composition.

Preferably, the composition comprises from 0.5 to 15 weight % of pea protein of the total weight of the composition, more preferably from 1.0 to 12.0 weight % of pea protein of the total weight of the composition, even more preferably from 2 to 10.0 weight % of pea protein of the total weight of the composition, most preferably from 2.63 to 9.0 weight % of pea protein of the total weight of the composition.

Preferably, the composition comprises from 0.5 to 15 weight % of corn protein of the total weight of the composition, more preferably from 1.0 to 12.0 weight % of corn protein of the total weight of the composition, even more preferably from 2 to 10.0 weight % of corn protein of the total weight of the composition, most preferably from 2.63 to 9.0 weight % of corn protein of the total weight of the composition.

Preferably, the composition comprises from 2.63 to 9.0 weight % of pea protein of the total weight of the composition and from 2.63 to 9.0 weight % of corn protein of the total weight of the composition.

Preferably, wherein the composition comprises the pea protein and corn protein at a ratio of from 20:80 to 80:20 respectively, even more preferably at a ratio of from 60:40 to 40:60 respectively, even more preferably at a ratio of from 80:20 to 40:60 respectively, most preferably at a ratio of 50:50 respectively.

Preferably, the pea protein and corn protein are not present in the composition as a blend.

Preferably, the pea protein is not present as pea flour and corn protein is not present as corn flour nor as pure zein protein. In particular, the corn protein comprises both zein and non-zein corn proteins.

Preferably, the composition is substantially free of pea flour and pea protein concentrate.

Preferably, the composition is substantially free of corn flour.

Preferably, the composition comprises both zein and non-zein corn proteins.

### The Composition as an Emulsion

The composition can be an emulsion. The composition as an emulsion according to the presently described invention has various desirable properties, which make the composition useful in a meat analogue food product, in particular an emulsified meat analogue food product.

The composition as an emulsion comprises a pea protein, a corn protein, water and an oil. Preferably, the pea protein comprises at least 70 weight % protein of the total weight of the pea protein, more preferably at least 75 weight % protein of the total weight of the pea protein, most preferably at least 80 weight % protein of the total weight of the pea protein. Preferably, the corn protein comprises at least 75 weight % protein of the total weight of the corn protein, more preferably at least 80 weight % protein of the total weight of the corn protein, most preferably at least 85 weight % protein of the total weight of the corn protein. Preferably, the peat protein comprises at least 80 weight % protein of the total weight of the pea protein and the corn protein comprises at least 85 weight % protein of the total weight of the corn protein.

The pea protein may be sourced from legumes by the method set out in US2021/0401022 A1 and/or any method well-known in the art. The disclosures of the listed patents/patent applications are incorporated by reference in their entirety.

The corn protein may be sourced from corn by the method set out in PCT/US2017/023988, (publication number WO2017/165748), PT/US2017/055498 (publication number WO2018/058150), PCT/US2018/038541 (publication number WO2018/237030), PCT/US2018/045029 (publication number WO2019/028263), PCT/US2018/050447 (publication number WO/2019/060179), PCT/US2018/052153 (publication number WO2019/060673), PCT/US2017/023999 (publication number WO2017/165756), PCT/US2016/024020 (WO2016/154441) and/or PCT/US2019/059482 (publication number WO2020/092964) and/or any method well-known in the art. The disclosures of the listed patents/patent applications are incorporated by reference in their entirety.

Preferably, the pea protein in the composition as an emulsion is non-hydrolysed.

Preferably, the pea protein in the composition as an emulsion is an isolate, for instance pea protein isolates Radipure® S or Puris™ Pea 870.

Preferably, the corn protein in the composition as an emulsion is an isolate, i.e. CPI.

Preferably, the corn protein in the composition as an emulsion is non-hydrolysed.

Preferably the corn protein is a (non-hydrolysed) corn protein isolate (CPI) obtainable according to the methods described above and having the properties as described above (see “The Composition” section).

Preferably, the pea protein in the composition as an emulsion is a non-hydrolysed pea protein isolate and the corn protein in the composition as an emulsion is a non-hydrolysed corn protein isolate (CPI), as described above.

Preferably, the composition as an emulsion comprises from 1 to 30 weight % of pea protein and corn protein of the total weight of the composition as an emulsion, more preferably from 2 to 24 weight % of pea protein and corn protein of the total weight of the composition as an emulsion, even more preferably from 4 to 20 weight % of pea protein and corn protein of the total weight of the composition as an emulsion, even more preferably from 5 to 19 weight % of pea protein and corn protein of the total weight of the composition as an emulsion, most preferably from 5.25 to 18.0 weight % of pea protein and corn protein of the total weight of the composition as an emulsion.

Preferably, the composition as an emulsion comprises from 0.5 to 15 weight % of pea protein of the total weight of the composition as an emulsion, more preferably from 1.0 to 12.0 weight % of pea protein of the total weight of the composition as an emulsion, even more preferably from 2 to 10.0 weight % of pea protein of the total weight of the composition as an emulsion, most preferably from 2.63 to 9.0 weight % of pea protein of the total weight of the composition as an emulsion.

Preferably, the composition as an emulsion comprises from 0.5 to 15 weight % of corn protein of the total weight of the composition as an emulsion, more preferably from 1.0 to 12.0 weight % of corn protein of the total weight of the composition as an emulsion, even more preferably from 2 to 10.0 weight % of corn protein of the total weight of the composition as an emulsion, most preferably from 2.63 to 9.0 weight % of corn protein of the total weight of the composition as an emulsion.

Preferably, the composition as an emulsion comprises from 2.63 to 9.0 weight % of pea protein of the total weight of the composition as an emulsion and from 2.63 to 9.0 weight % of corn protein of the total weight of the composition as an emulsion.

Preferably, wherein the composition as an emulsion comprises the pea protein and corn protein at a ratio of from 20:80 to 80:20 respectively, even more preferably at a ratio of from 60:40 to 40:60 respectively, even more preferably at a ratio of from 80:20 to 40:60 respectively, most preferably at a ratio of 50:50 respectively.

Preferably, wherein the oil in the composition as an emulsion is vegetable oil, vegetable fats and/or a mixture of vegetable oil and vegetable fats. Preferably, wherein the vegetable oil is, but not limited to, rapeseed oil and/or canola oil. Preferably, the oil is present in the composition as an emulsion at from 10 to 70 weight % of the total weight of the composition as an emulsion, more preferably from 12.5 to 75 weight % of the total weight of the composition as an emulsion, most preferably from 15 to 63 weight % of the total weight of the composition as an emulsion.

Preferably, the water is present in the composition as an emulsion at from 20 to 80 weight % of the total weight of the composition as an emulsion, more preferably from 25 to 70 weight % of the total weight of the composition as an emulsion, even more preferably from 30 to 65 weight % of the total weight of the composition as an emulsion, most preferably from 31.0 to 61.0 weight % of the total weight of the composition as an emulsion.

Preferably, the composition as an emulsion further comprises texturising and stabilising systems, sugars, salt, colourants, flavourings, and/or any combination thereof.

Preferably, the texturising and stabilising system is a multiple ingredient system. Preferably, the texturising and stabilising system comprises hydrocolloids, starch and/or dextrose. Preferably, the texturising and stabilising system comprises methylcellulose, carrageenan and/or konjac gum. Preferably, the texturising and stabilising system is present in the composition as an emulsion at from 1 to 10 weight % of the total weight of the composition as an emulsion, more preferably from 3 to 7 weight % of the total weight of the composition as an emulsion, more preferably from 4 to 6 weight % of the total weight of the composition as an emulsion, most preferably at 5 weight % of the total weight of the composition as an emulsion.

Preferably, the sugar is sucrose, dextrose, lactose, maltose, glucose galactose and/or any combination thereof. Preferably, the sugar is present at from 0.1 to 1 weight % of the total weight of the composition as an emulsion, more preferably from 0.3 to 0.7 weight % of the total weight of the composition as an emulsion, more preferably from 0.4 to 0.6 weight % of the total weight of the composition as an emulsion, most preferably at 0.5 weight % of the total weight of the composition as an emulsion. Preferably, the sugar is dextrose and is present at 0.5 weight % of the total weight of the composition as an emulsion.

Preferably, the salt is present at from 0.1 to 5 weight % of the total weight of the composition as an emulsion, more preferably from 0.5 to 2.5 weight % of the total weight of the emulsion, more preferably from 0.8 to 2 weight % of the total weight of the composition as an emulsion, more preferably from 1 to 1.5 weight % of the total weight of the composition as an emulsion, more preferably from 1.1 to 1.3 weight % of the total weight of the composition as an emulsion, most preferably at 1.2 weight % of the total weight of the composition as an emulsion.

Preferably, the colourant is red oxide, safflower, turmeric, carrot, beetroot, radish and/or paprika extract. Preferably, the total amount of colourant present in the composition as an emulsion is at from 0.001 to 0.2 weight % of the total weight of the composition as an emulsion, more preferably from 0.02 to 0.1 weight % of the total weight of the composition as an emulsion, more preferably from 0.05 to 0.08 weight % of the total weight of the composition as an emulsion, most preferably at 0.065 weight % of the total weight of the composition as an emulsion. Preferably, the colourant is red oxide and paprika and is present at 0.065 weight % of the total weight of the composition as an emulsion. Preferably, the composition as an emulsion comprises red oxide as the colourant and the red oxide is present at from 0.01 to 0.03 weight % of the total weight of the composition as an emulsion, more preferably from 0.015 to 0.025 weight % of the total weight of the composition as an emulsion, most preferably at 0.02 weight % of the total weight of the composition as an emulsion. Preferably, the comprises paprika as the colourant and the paprika is present at from 0.03 to 0.06 weight % of the total weight of the composition as an emulsion, more preferably from 0.04 to 0.05 weight % of the total weight of the composition as an emulsion, most preferably at 0.045 weight % of the total weight of the composition as an emulsion.

Preferably, the flavouring is present at from 0.1 to 5 weight % of the total weight of the composition as an emulsion, more preferably from 1 to 3 weight % of the total weight of the composition as an emulsion, most preferably at 2 weight % of the total weight of the composition as an emulsion.

The composition as an emulsion may also include a starch. The starch may be sourced from maize, potatoes, tapioca, wheat, peas and/or rice. Preferably, the starch is a waxy starch. Preferably, the starch is a waxy maize starch. Preferably, the starch is a stabilised and crosslinked waxy maize starch. Preferably, the starch is present at from 0.1 to 5 weight % of the total weight of the emulsion, more preferably from 0.5 to 2.5 weight % of the total weight of the emulsion, more preferably from 0.8 to 1.2 weight % of the total weight of the emulsion, more preferably from 0.9 to 1.1 weight % of the total weight of the emulsion, most preferably at 1.0 weight % of the total weight of the emulsion. Preferably, the starch is a stabilised and crosslinked waxy maize starch and is present at 1.0 weight % of the total weight of the emulsion.

### Kit

Another aspect of the present invention relates to a kit for producing a plant-based emulsified food product. The kit comprises a pea protein and a corn protein.

Preferably, the kit comprises a pea protein, a corn protein, oil and water.

Preferably, the kit further comprises one or more of texturising and stabilising systems, sugars, salt, colourants and/or flavourings.

The Composition and/or Composition as an Emulsion in a Food Product

Another aspect of the present invention relates to the composition and/or the composition as an emulsion in a food product.

The food product may be a plant-based emulsified food product.

Preferably the plant-based emulsified food product is a vegetarian for vegan food product.

Preferably, the plant-based emulsified food product is a meat analogue food product, in particular an emulsified meat analogue food product. The meat analogue food product may be a heat-treated food product. Meat analogue food products include, but are not limited to, meat-free sausages, meat-free hot dogs, meat-free cold cuts, meat-free frankfurters and/or meat-free sliced deli meats.

Alternatively, the food product may partially contain some meat-derived ingredients and partially the composition according to the invention. In this case, the composition according to the invention can be used as a “meat extender” in a food product. By “meat extender” it is meant a composition that partially replaces meat-derived ingredients in a food product. Therefore, the invention covers also the use of the composition according to the invention as a meat extender in the preparation of a partially plant-based, partially meat-derived emulsified food product. The food product can be a sausage, hot dog, cold cuts, frankfurters and/or sliced deli meats.

Preferably, the food product is a ready to eat food product. The ready to eat food product may be a ready to eat meat analogue.

Preferably, the food product is a cooked food product.

### Method of Making the Composition

Another aspect of the present invention relates to a method of making the composition.

The method of making the composition may comprise the following steps:
(a) providing a pea protein;
(b) providing a corn protein
(c) combining the pea protein and corn protein to form the composition.

Preferably, the method of making the composition does not form a composition wherein the pea protein and corn protein are present as a blend.

### Method of Making the Composition as an Emulsion

Another aspect of the present invention relates to a method of making the composition as an emulsion.

The method of making the composition as an emulsion may comprise the following steps:
(a) providing a pea protein;
(b) providing water;
(c) combining the pea protein and water to form a hydrated pea protein;
(d) providing a corn protein;
(e) combining the corn protein with the hydrated pea protein to form a mixture;
(f) providing an oil; and
(g) combining the oil with the mixture until an emulsion (i.e., the composition as an emulsion) is formed.

Preferably, steps (a) to (g) are carried out in the order of (a), (b), (c), (d), (e), (f) and then (g).

Preferably, the water is at a temperature of from 0.1 to 10 °C, more preferably from 0.5 to 7 °C, even more preferably from 1 to 5 °C, most preferably from 2 to 4 °C.

Preferably, the pea protein and water are combined by mixing at a speed of from 100 to 1500 RPM, more preferably from 250 to 1250 RPM, most preferably from 500 to 1000 RPM during step (c).

Preferably, the corn protein and hydrated pea protein are combined by mixing at a speed of from 500 to 4000 RPM, more preferably from 750 to 3500 RPM, most preferably from 1000 to 3000 RPM during step (e).

Preferably, the method of making the composition as an emulsion includes the step of combining the pea protein, water, hydrated pea protein and/or corn protein with a texturising and stabilising system, sugar, salt, colourant, flavouring, and/or any combination thereof. Preferably, the pea protein, water, hydrated pea protein and/or corn protein are combined with a texturising and stabilising system, sugar, salt, colourant, flavouring, and/or any combination thereof by mixing at a speed of from 100 to 1500 RPM, more preferably from 250 to 1250 RPM, most preferably from 500 to 1000 RPM. Preferably, the method of making the composition as an emulsion includes the step of combining the pea protein with water to form a hydrated pea protein, and then combining the hydrated pea protein with a texturising and stabilising system, sugar, salt, colourant, flavouring and/or any combination thereof by mixing at a speed of from 500 to 1000 RPM.

Preferably, the oil in step (f) is a vegetable oil, a vegetable fat or a mixture of a vegetable oil and vegetable fat.

Preferably, the mixture and oil are combined by mixing at a speed of from 4000 to 6000 RPM, more preferably from 4500 to 6000 RPM, most preferably from 5000 to 6000 RPM during step (g).

Preferably, step (g) is carried out at least partially under vacuum. Preferably, the vacuum is set to be at from 75 to 95% vacuum, more preferably from 80 to 90% vacuum, most preferably at 85% vacuum. Preferably, step (g) is carried out for from 60 to 120 seconds, more preferably from 80 to 100 seconds, most preferably 90 seconds. Preferably, step (g) is carried out at a speed of from 5000 to 6000 RPM, more preferably from 5500 to 6000 RPM, most preferably at 6000 RPM. Preferably, the vacuum is set to be at 85% vacuum, the oil and mixture are combined at least partially under vacuum for 90 seconds and at a speed of 6000 RPM.

Preferably, the corn protein may be provided in an oil. Preferably, the corn protein is provided by being dispersed in an oil. When the corn protein is provided in an oil, step (e) is carried out until an emulsion is formed and step (f) and (g) are not present. Preferably, when the corn protein is provided in an oil, the corn protein in an oil and the hydrated pea protein are combined at least partially under vacuum. Preferably, the vacuum is set to be at from 75 to 95% vacuum, more preferably from 80 to 90% vacuum, most preferably at 85% vacuum. Preferably, the corn protein in an oil and the hydrated pea protein are combined at least partially under vacuum for from 60 to 120 seconds, more preferably from 80 to 100 seconds, most preferably 90 seconds. Preferably, the corn protein in an oil and the hydrated pea protein are combined at least partially under vacuum at a speed of from 5000 to 6000 RPM, more preferably from 5500 to 6000 RPM, most preferably at 6000 RPM. Preferably, the vacuum is set to be at 85% vacuum, the corn protein in an oil and the hydrated pea protein are combined at least partially under vacuum for 90 seconds and at a speed of 6000 RPM.

Method of Making a Cooked Food Product from the Composition as an Emulsion

Another aspect of the present invention relates to a method of making a cooked food product comprising the composition as an emulsion.

The method of making the cooked food product comprises the steps:
(a) to (g) as set out under the heading “Method of making the composition as an emulsion”; and
(h) cooking the emulsion produced in step (g) to form a cooked food product.

Preferably, step (h) can be separated into separate forming and cooking steps. The separate cooking steps include, but are not limited to, the following steps:
(h)(i) forming the emulsion to produce a shaped emulsion;
(h)(ii) drying the surface of the shaped emulsion to form a dried emulsion;
(h)(iii) smoking the dried emulsion to form a smoked emulsion; and
(h)(iv) steaming the smoked emulsion to form a cooked food product.

Alternatively, the method of making the cooked food product comprises the following steps:
(a) to (g) as set out under the heading “Method of making the composition as an emulsion”;
(h)(v) placing the emulsion produced in step (g) in a mold, such as but not limited to, a can; and
(h)(vi) steaming the product of step (h)(v) to form a cooked food product.

Preferably, step (h)(ii) is carried out at a temperature of from 40 to 60 °C, more preferably from 45 to 55 °C, most preferably at 50 °C.

Preferably step (h)(iii) is carried out at a temperature of from 50 to 70 °C, more preferably from 55 to 65 °C, most preferably at 60 °C.

Preferably, step (h)(iv) and step (h)(vi) are carried out at a temperature of from 75 to 95 °C, more preferably from 80 to 90 °C, most preferably at 85 °C. Preferably step (h)(iv) and step (h)(vi) are carried out until the cooked food product has a core temperature of from 70 to 90 °C, more preferably from 75 to 85 °C, most preferably at 80 °C.

Preferably, step (h)(ii) is carried out at a temperature of 50 °C, step (h)(iii) is carried out at a temperature of 60 °C and step (h)(iv) is carried out at a temperature of 85 °C and until the cooked food product has a core temperature of 80 °C.

Preferably, the methods further include the step of showering the cooked food product with water. Preferably, the cooked food product is showered with cold water. Preferably, the cold water is at a temperature of from 5 to 20 °C, more preferably from 7 to 8 °C, more preferably from 9 to 17 °C, most preferably from 10 to 16 °C.

Preferably, the methods further include the step of cooling the cooked food product until the cooked food product is at a temperature of from 1 to 7 °C, more preferably from 1.5 to 6 °C, most preferably from 2 to 4 °C.

### Method of Making the Food Product

Another aspect of the present invention relates to a method of making a food product comprising the composition and/or composition as an emulsion.

The method of making the food product comprises the steps:
(a) providing the composition and/or a composition as an emulsion; and
(b) combining the composition and/or composition as an emulsion with at least one food product.

### EXAMPLES

The following are non-limiting examples that discuss, with reference to tables and figures, the advantages of the present invention. The examples set forth herein are merely examples among other possible examples.

In Examples 1 to 5 below “pea protein” refers to “pea protein isolate” and “corn protein” refers to “corn protein isolate” i.e. “CPI”.

### Example 1: The Method for Making a Composition as an Emulsion

In this non-limiting example of the present invention, the method of making the composition as an emulsion is set out. The below method was used to produce a composition as an emulsion for all the following examples. The method includes the following steps:
(a) providing a pea protein;
(b) providing water, wherein the water is at a temperature of from 2 to 4 °C;
(c) combining the pea protein and water by mixing at from 500-1000 RPM to form a hydrated pea protein;
(d) providing a salt and combining the salt with the hydrated pea protein by mixing at from 500-1000 RPM;
(e) providing flavourings and colourants and combining the flavourings and colourants with the product of step (d) by mixing at from 500 to 1000 RPM, wherein the colourants are paprika and red oxide;
(f) providing a sugar, a starch and a texturising and stabilising system and combining the sugar, starch and texturising and stabilising system with the product of step (e) by mixing at from 500 to 1000 RPM, wherein the sugar is dextrose, the starch is a stabilised and crosslinked waxy maize starch and the texturising and stabilising system comprises methylcellulose, carrageenan and konjac gum;
(g) providing a corn protein;
(h) combining the corn protein with the product of step (f) by mixing at from 1000 to 3000 RPM to form a mixture;
(i) providing an oil and a vegetable fat, wherein the oil is rapeseed oil, and the vegetable fat is an interesterified blend of cocoa butter with rapeseed oil;
(j) combining the oil with the mixture by mixing at from 5000 to 6000 RPM; and
(k) emulsifying the product of step (j) under vacuum to form an emulsion, wherein the product of step (j) is under vacuum for 90 seconds at a speed of 6000 RPM and wherein the vacuum is at 85% vacuum.

### Example 2: The Method for Making a Cooked Product Used in the Following Examples

In this non-limiting example of the present invention, the method of making a cooked product from the emulsion produced in Example 1 is set out. The method includes the following steps:
(a) to (k) as set out in Example 1;
(l) forming the emulsion of step (k) to produce a shaped emulsion by stuffing a vegan hotdog casing with the emulsion;
(m) drying the surface of the shaped emulsion at a temperature of 50 °C to form a dried emulsion;
(n) smoking the dried emulsion at a temperature of 60 °C to form a smoked emulsion;
(o) steaming the smoked emulsion to form a cooked food product, wherein the steaming occurs at a temperature of 85 °C and until the cooked food product has a core temperature of 80 °C;
(p) showering the cooked food product with cold water that is at a temperature of from 10 to 16 °C; and,
(q) cooling the cooked food product to a temperature of from 2 to 4 °C.

### Example 3: Producing an Emulsion Comprising Pea Protein and Corn Protein

In this non-limiting example of the present invention, three emulsions were made by following the method set out in Example 1. The three emulsions made were called Emulsion 1, Emulsion 2 and Emulsion 3. The composition of each emulsion is set out in Table 1.

TABLE 1
The composition of Emulsion 1, Emulsion 2 and
Emulsion 3. Each ingredient is displayed
in weight % of the total weight of the emulsion.

| Ingredient | Emulsion 1 | Emulsion 2 | Emulsion 3 |
|---|---|---|---|
| Water | 60.235 | 60.235 | 60.235 |
| Rapeseed oil | 12.00 | 12.00 | 12.00 |
| Pea protein | 15.00 | 12.00 | 7.50 |
| Corn protein | 0.00 | 3.00 | 7.50 |
| A texturising and | 5.00 | 5.00 | 5.00 |
| stabilising system | | | |
| Vegetable fat | 3.00 | 3.00 | 3.00 |
| (interesterified blend | | | |
| of cocoa butter with | | | |
| rapeseed oil) | | | |
| Starch | 1.00 | 1.00 | 1.00 |
| Sugar (dextrose) | 0.50 | 0.50 | 0.50 |
| Salt | 1.20 | 1.20 | 1.20 |
| Colourant: Red oxide | 0.02 | 0.02 | 0.02 |
| Colourant: Paprika | 0.045 | 0.045 | 0.045 |
| Flavourings | 2.00 | 2.00 | 2.00 |

The texturising and stabilising system comprises methylcellulose, carrageenan and konjac gum.

The emulsions were then cooked by following the method set out in Example 2. The cooked food products were called: Food Product 1 (made from Emulsion 1), Food Product 2 (made from Emulsion 2) and Food Product 3 (made from Emulsion 3).

The food products were visually and taste analysed. Advantageously, partial replacement of pea protein with corn protein improved colour (Food Product 2 and Food Product 3 were lighter in colour than Food Product 1), texture (Food Product 2 and Food Product 3 had more favourable bite and firmness than Food Product 1) and mouthfeel and taste (Food Product 2 and Food Product 3 were able to mask the pea aftertaste present in Food Product 1). Further advantageously, Food Product 2 and Food Product 3 had improved freeze thaw stability compared to Food Product 1.

### Example 4: Producing an Emulsion and Cooked Product Comprising Pea Protein and Corn Protein

In this non-limiting example of the present invention, four emulsions were made by following the method set out in Example 1. The four emulsions made were called Emulsion 4, Emulsion 5, Emulsion 6 and Emulsion 7. Each weight 0% is for the total weight of the emulsion. The composition of each emulsion is set out in Table 2.

TABLE 2
The composition of Emulsion 4, Emulsion 5, Emulsion
6 and Emulsion 7. Each ingredient is displayed
in weight % of the total weight of the emulsion.

| Ingredient | Emulsion 4 | Emulsion 5 | Emulsion 6 | Emulsion 7 |
|---|---|---|---|---|
| Pea protein (1) | 14.30 | 0.00 | 0.00 | 7.15 |
| Pea protein (2) | 0.00 | 14.30 | 0.00 | 0.00 |
| Corn protein | 0.00 | 0.00 | 14.30 | 7.15 |
| Water | 42.85 | 42.85 | 42.85 | 42.85 |
| Rapeseed oil | 42.85 | 42.85 | 42.85 | 42.85 |

The emulsions were then analysed. From a visual analysis, Emulsion 5, Emulsion 6 and Emulsion 7 provided creamy, stable emulsions. Emulsion 4 provided a thick and cuttable emulsion. Images of Emulsion 4, Emulsion 5, Emulsion 6 and Emulsion 7 are shown in FIG. 1.

The emulsions were then cooked to form a food product. The method of cooking the emulsions included the following steps:
(l) placing each emulsion into a can;
(m) steaming the product of step (1) to form a cooked food product, wherein the steaming occurred at a temperature of 85 °C and until the cooked food product had a core temperature of 80 °C;
(n) showering the cooked food product with cold water that is at a temperature of from 10 to 16 °C; and
(o) cooling the cooked food product to a temperature of from 2 to 4 °C.

The cooked food products were called: Food Product 4 (made from Emulsion 4), Food Product 5 (made from Emulsion 5), Food Product 6 (made from Emulsion 6) and Food Product 7 (made from Emulsion 7).

The Food Products were visually analysed. Table 3 sets out the results from the visual analysis. Images for Food Product 4, Food Product 5, Food Product 6 and Food Product 7 are shown in FIG. 2.

TABLE 3
Results from the visual analysis of Food Product 4, Food
Product 5, Food Product 6 and Food Product 7.

| Food Product | Visual Analysis |
|---|---|
| Food Product 4 | Gelled, firm product, released no water or oil |
| | upon cooking, cuttable |
| Food Product 5 | Very soft and stable, released no water or oil |
| | upon cooking, not cuttable |
| Food Product 6 | Unstable resulting in water separation, |
| | cuttable |
| Food Product 7 | Firm and stable, released no water or oil upon |
| | cooking and cuttable. |

Advantageously, the use of pea protein and corn protein provided creamy, stable and easy-to-handle emulsions and soft and stable food products that were firm, cuttable and did not have any oil or water separation upon cooking.

### Example 5: Producing an Emulsion and Cooked Product Comprising Pea Protein and Corn Protein

In this non-limiting example of the present invention, four emulsions were made by following the method set out in Example 1. The four emulsions made were called Emulsion 8, Emulsion 9, Emulsion 10 and Emulsion 11. Each weight % is for the total weight of the emulsion The composition of each emulsion is set out in Table 4.

TABLE 4
The composition of Emulsion 8, Emulsion 9, Emulsion
10 and Emulsion 11. Each ingredient is displayed
in weight % of the total weight of the emulsion.

| Ingredient | Emulsion 8 | Emulsion 9 | Emulsion 10 | Emulsion 11 |
|---|---|---|---|---|
| Pea protein (1) | 5.25 | 0.00 | 0.00 | 2.63 |
| Pea protein (2) | 0.00 | 5.25 | 0.00 | 0.00 |
| Corn protein | 0.00 | 0.00 | 5.25 | 2.63 |
| Water | 31.75 | 31.75 | 31.75 | 31.75 |
| Rapeseed oil | 63.00 | 63.00 | 63.00 | 63.00 |

The emulsions were then analysed. From a visual analysis, Emulsion 8 and Emulsion 9 provided creamy, stable emulsions, Emulsion 10 provided a pourable emulsion with oil droplets on the surface and Emulsion 11 advantageously provided a glossy and stable emulsion. A glossy emulsion is advantageous because the glossy emulsion indicates that there is very good oil emulsification within the emulsion. Images of Emulsion 8, Emulsion 9, Emulsion 10 and Emulsion 11 are shown in FIG. 3.

The emulsions were then cooked to form a food product. The method of cooking the emulsions included the following steps:
(l) placing each emulsion into a can;
(m) steaming the product of step (1) to form a cooked food product, wherein the steaming occurred at a temperature of 85 °C and until the cooked food product had a core temperature of 80 °C;
(n) showering the cooked food product with cold water that is at a temperature of from 10 to 16 °C; and
(o) cooling the cooked food product to a temperature of from 2 to 4 °C.

The cooked food products were called: Food Product 8 (made from Emulsion 8), Food Product 9 (made from Emulsion 9), Food Product 10 (made from Emulsion 10) and Food Product 11 (made from Emulsion 11). The Food Products were visually analysed. Table 5 sets out the results from the visual analysis. Images for Food Product 8, Food Product 9, Food Product 10 and Food Product 11 are shown in FIG. 4.

TABLE 5
Results from the visual analysis of Food Product 8, Food
Product 9, Food Product 10 and Food Product 11.

| Food Product | Visual Analysis |
|---|---|
| Food Product 8 | Soft and stable food product, released no |
| | water or oil upon cooking |
| Food Product 9 | Very soft food product, released no water or |
| | oil upon cooking |
| Food Product 10 | Unstable food product, water separation, |
| | pourable instead of cuttable |
| Food Product 11 | Soft and stable food product, released no |
| | water or oil upon cooking, |

Advantageously, the use of pea protein and corn protein provided a glossy emulsion and a soft and stable food product, which had improved texture and emulsion stability compared to food products not comprising pea protein and corn protein.

### Example 6

In the following examples, several emulsions were made by following different methods as set out below to compare the hotdog according to the invention with hotdogs made with either individual plant proteins or with the same combination of proteins, but added together rather than separately. The composition of each emulsion is set out in Table 6.

TABLE 6
The composition of various emulsions. Each ingredient is displayed
in weight % of the total weight of the emulsion.

| | Emulsion A1 | Emulsion | | |
|---|---|---|---|---|
| | (separate | C1 | Emulsion | |
| | addition of | (addition | C2 | Emulsion |
| | proteins | of both | (100% Pea | C3 |
| | according to | proteins | protein | (100% |
| Ingredient | invention) | together) | isolate) | CPI) |
| Cold Water (<2 °C) | 60.23 | 60.23 | 60.23 | 60.23 |
| Pea protein isolate | 7.50 | 7.50 | 15.00 | 0 |
| Corn protein isolate | 7.50 | 7.50 | 0 | 15.00 |
| (CPI) | | | | |
| A texturising and | 5.00 | 5.00 | 5.00 | 5.00 |
| stabilising system | | | | |
| Vegetable fat blend | 3.00 | 3.00 | 3.00 | 3.00 |
| (interesterified blend | | | | |
| of cocoa butter with | | | | |
| rapeseed oil) | | | | |
| Rapeseed oil | 12.00 | 12.00 | 12.00 | 12.00 |
| Starch | 1.00 | 1.00 | 1.00 | 1.00 |
| Sugar (dextrose) | 0.50 | 0.50 | 0.50 | 0.50 |
| Salt | 1.20 | 1.20 | 1.20 | 1.20 |
| Colourant: Red oxide | 0.02 | 0.02 | 0.02 | 0.02 |
| Colourant: Paprika | 0.05 | 0.05 | 0.05 | 0.05 |
| Flavourings | 2.00 | 2.00 | 2.00 | 2.00 |

The method for the preparation of Emulsion A1 was as provided in Example 1.

The method for the preparation of Emulsion C1, wherein pea protein and corn protein were added together as a blend, was as follows:
(a) providing a pea protein isolate and CPJ premixed blend;
(b) providing water, wherein the water is at a temperature of from 2 to 4 °C;
(c) combining the premixed blend and water by mixing at from 500-1000 RPM to form a hydrated pea protein and corn protein mixture;
(d) providing a salt and combining the salt with the hydrated pea protein and corn protein mixture by mixing at from 500-1000 RPM;
(e) providing flavourings and colourants and combining the flavourings and colourants with the product of step (d) by mixing at from 500 to 1000 RPM, wherein the colourants are paprika and red oxide;
(f) providing a sugar, a starch and a texturising and stabilising system and combining the sugar, starch and texturising and stabilising system with the product of step (e) by mixing at from 500 to 1000 RPM, wherein the sugar is dextrose, the starch is a stabilised and crosslinked waxy maize starch and the texturising and stabilising system comprises methylcellulose, carrageenan and konjac gum;
(g) providing an oil and a vegetable fat, wherein the oil is rapeseed oil, and the vegetable fat is an interesterified blend of cocoa butter with rapeseed oil;
(j) combining the oil with the product from step (f) by mixing at from 5000 to 6000 RPM; and
(k) emulsifying the product of step (j) under vacuum to form an emulsion, wherein the product of step (j) is under vacuum for 90 seconds at a speed of 6000 RPM and wherein the vacuum is at 85% vacuum.

The method for the preparation of Emulsion C2 or C3, wherein either only pea protein was used (Emulsion C2) or only corn protein was used (Emulsion C3) as the protein source:
(a) providing the appropriate plant protein isolate;
(b) providing water, wherein the water is at a temperature of from 2 to 4 °C; (c) combining the plant protein isolate and water by mixing at from 500-1000 RPM to form a hydrated plant protein;
(d) providing a salt and combining the salt with the hydrated plant protein by mixing at from 500-1000 RPM;
(e) providing flavourings and colourants and combining the flavourings and colourants with the product of step (d) by mixing at from 500 to 1000 RPM, wherein the colourants are paprika and red oxide;
(f) providing a sugar, a starch and a texturising and stabilising system and combining the sugar, starch and texturising and stabilising system with the product of step (e) by mixing at from 500 to 1000 RPM, wherein the sugar is dextrose, the starch is a stabilised and crosslinked waxy maize starch and the texturising and stabilising system comprises methylcellulose, carrageenan and konjac gum;
(g) providing an oil and a vegetable fat, wherein the oil is rapeseed oil, and the vegetable fat is an interesterified blend of cocoa butter with rapeseed oil;
(j) combining the oil with the product from step (f) by mixing at from 5000 to 6000 RPM; and
(k) emulsifying the product of step (j) under vacuum to form an emulsion, wherein the product of step (j) is under vacuum for 90 seconds at a speed of 6000 RPM and wherein the vacuum is at 85% vacuum.

The emulsions were then each used to stuff vegan hot dog casings and cooked according to the following steps:
(l) forming the emulsion of step (k) to produce a shaped emulsion by stuffing the emulsion into a permeable peel-off cellulose casing;
(m) drying the surface of the shaped emulsion at a temperature of 50 °C to form a dried emulsion;
(n) smoking the dried emulsion at a temperature of 60 °C to form a smoked emulsion;
(o) steaming the smoked emulsion to form a cooked food product, wherein the steaming occurs at a temperature of 85 °C and until the cooked food product has a core temperature of 80 °C;
(p) showering the cooked food product with cold water that is at a temperature of from 10 to 16 °C; and,
(q) cooling the cooked food product to a temperature of from 2 to 4 °C.

The following observations in Table 7 were made on the dough texture and its stuffing properties:

TABLE 7
Observations during processing

| FOOD PRODUCT | DOUGH TEXTURE | STUFF PROPERTIES |
|---|---|---|
| Hot dog made with | Stickier and compacter dough | Less difficult to |
| Emulsion A1 | than 100% pea protein isolate | stuff than 100% |
| | but not as much as 100% CPI. | CPI. Several |
| | Homogenous. No water or oil | casings broken. |
| | release. | |
| Hot dog made with | Very sticky dough; sticker | More difficult to stuff |
| Emulsion C1 | than Emulsion A1 wherein | than Emulsion A1. |
| | corn protein and pea protein | More stickiness. Holes |
| | are added in separate steps. | and lines in the |
| | Homogenous. No water or oil | casing during stuffing |
| | release. | |
| Hot dog made with | Compact and sticky dough. | Easy to stuff. No |
| Emulsion C2 | Homogenous. No water or oil | broken casing. |
| | release. | No holes inside. |
| Hot dog made with | Much stickier than pea protein | Difficult to stuff due to |
| Emulsion C3 | isolate. Seems lighter in terms | stickiness. Several |
| | of compactness. | casings broken. |
| | Homogenous. No water or oil | |
| | release. | |

The cooking and freezing losses of the hotdogs are shown in FIG. 5. The cooking losses represent the amount of loss of material (oil, moisture etc.) during cooking of the chilled material. The freezing losses represent the amount of loss of material (oil, moisture etc.) from freeze thawing. The total losses is the sum of the cooking losses and the freezing losses.

Texture analyses at cold storage temperature (4 °C) of the hotdogs are shown in FIG. 6. Texture analysis was conducted on the food products immediately upon removal from cold storage at 4 °C. Note: The frozen food products (that had been stored in a freezer for 1 week) were first thawed in a refrigerator to 4 °C and then the texture analysis was conducted on the thawed food products immediately upon removal from the refrigerator.

Texture analyses at hot consumption temperature (40 °C) of the hotdogs are shown in FIG. 7. Texture analysis was conducted on the food products that were heated in hot water up to 40 °C. Chilled products were heated up upon removal from the refrigerator. The frozen products (that had been stored in a freezer for 1 week) were first thawed in a refrigerator to 4 °C and then heated in hot water up to 40 °C for the texture analysis.

The sensory analysis of the hotdogs with pea protein or corn protein as the only source of protein are shown in FIG. 8.

The sensory analysis of hotdogs with pea protein AND corn protein added either separately to form the emulsion or together are shown in FIG. 9.

The sensory analysis of hotdogs with pea protein AND corn protein added either separately to form the emulsion or together compared with pea protein alone are shown in FIG. 10.

Sensory analysis: The hotdogs heated to 40 °C in hot water were visually and taste analysed (blind) with a sensory panel of 5 people that made the ratings as shown in FIGS. 8, 9 and 10 and also made the below observations. The hotdogs that were chilled at 4 °C were removed from the refrigerator and heated up in hot water to 40 °C for the sensory analysis. The hotdogs that were frozen were first removed from the freezer and allowed to thaw in the refrigerator to 4 °C, after which they were removed from the refrigerator and heated up in hot water to 40 °C for the sensory analysis.

FIG. 8: Hotdogs made with Emulsions C2 and C3:

### Impact of Freezing Step:

Hotdogs with Emulsion C2 after freeze/thaw—Dryer, softer, more sticky, weaker flavour and less aftertaste after thawing
Hotdogs with Emulsion C3 after freeze/thaw—keeps similar texture properties and taste

### Difference Between Proteins:

Bite—Hotdogs with Emulsion C2 and C3 had comparable firm bite
Chewiness—Hotdogs with Emulsion C2 and C3 comparable chew
Juiciness—Hotdogs with Emulsion C3 dryer, Hotdogs with Emulsion C2 juicier
Comparable smokey flavour between C2 and C3 when tasted fresh. However, C3 after freeze/thaw lost the smokey taste aftertaste and had an increased aftertaste

FIG. 9: Hotdogs made with Emulsions A1 and C1:
Freezing step improved flavour balance and reduced aftertaste
Better chewiness and juciness when made by separate addition of corn protein isolate and pea protein isolate compared to the premixed blend prior to hydration

FIG. 10: Hotdogs made with Emulsions A1, C1 and C2:
Taste—combination pea protein isolate with corn protein isolate improved overall flavour and increased aftertaste
Bite—for the combination pea protein isolate with corn protein isolate less pronounced impact on firmness in bite when the hotdogs were exposed to the freeze/thaw
Chewiness—combination pea protein isolate with corn protein isolate improved chewiness in defrosted hot dogs
Juiciness—combination pea protein isolate with corn protein isolate increased juiciness and maintained juiciness after freeze/thaw step where pea protein isolate alone is very dry after freeze/thaw

To summarize on Example 6:

### Hot Dogs Production Process:

Generally, the use of the combination of corn protein isolate (CPI) and pea protein isolate increased dough stickiness and compactness, however this was still acceptable for industrial stuffing into the permeable peel-off casing.

Addition of pea protein isolate and corn protein isolate in 2 different processing steps (firstly hydration of pea protein alone, secondly addition of corn protein alone before the oils i.e. after binding system homogenized, just before emulsification with oil& fat) gave generally better dough performance compared to a preparation of a corn protein and pea protein premix blend which is hydrated before the binding system addition.

### Losses/Yield:

Generally, addition of corn protein isolate to pea protein isolate improved total yield. Inclusion of CPI and pea protein isolate reduced both cooking losses as well as freezing losses.

Comparing addition of each protein separately or together in a premix prior to hydration, the addition of the two proteins separately resulted in improved cooking yield.

### Texture Analyses:

At cold storage (4 °C)—CPI alone was the firmest followed by pea protein isolate. Generally freezing step reduced firmness and knack/snap effect. However, no significant texture difference between 2 different production process in 2 protein systems observed at this storage temperature.

At hot consumption temperature (40 °C)—very hard texture for CP alone, in fact already too brittle; combination of CPI and pea protein isolate increased firmness. Generally the freezing step reduced firmness.

### Example 7

In the following examples, several emulsions were made by following different methods as set out below. The composition of each emulsion is set out in Table 8.

TABLE 8
The composition of various emulsions comparing different plant
protein sources and their combinations. Each ingredient
is displayed in weight % of the total weight of the emulsion.

| | Emulsion | Emulsion | | Emulsion |
|---|---|---|---|---|
| | A2 | C4 | Emulsion | C6 |
| | (separate | (separate | C5 | (separate |
| | addition of | addition of | (separate | addition |
| | protein | pea protein | addition of | of pea |
| | isolates | isolate and | pea protein | protein |
| | according to | zein | concentrate | isolate and |
| Ingredient | invention) | protein) | and CPI) | corn flour) |
| Cold Water (<2 °C) | 60.23 | 60.23 | 60.23 | 60.23 |
| Pea protein isolate | 7.50 | 7.50 | 0 | 7.50 |
| (Radipure ® S) | | | | |
| Pea protein | 0 | 0 | 7.50 | 0 |
| concentrate (PPC) | | | | |
| Corn protein isolate | 7.50 | 0 | 7.50 | 0 |
| (CPI) | | | | |
| Zein protein | 0 | 7.50 | 0 | 0 |
| Corn flour | 0 | 0 | 0 | 7.50 |
| A texturising and | 5.00 | 5.00 | 5.00 | 5.00 |
| stabilising system | | | | |
| Vegetable fat blend | 3.00 | 3.00 | 3.00 | 3.00 |
| (interesterified blend | | | | |
| of cocoa butter with | | | | |
| rapeseed oil) | | | | |
| Rapeseed oil | 12.00 | 12.00 | 12.00 | 12.00 |
| Starch | 1.00 | 1.00 | 1.00 | 1.00 |
| Sugar (dextrose) | 0.50 | 0.50 | 0.50 | 0.50 |
| Salt | 1.20 | 1.20 | 1.20 | 1.20 |
| Colourant: Red oxide | 0.02 | 0.02 | 0.02 | 0.02 |
| Colourant: Paprika | 0.05 | 0.05 | 0.05 | 0.05 |
| Flavourings | 2.00 | 2.00 | 2.00 | 2.00 |

Zein protein was obtained from FoZein Products (a Flo Chemical Corporation Company) and had a zein content of 90.81%0.

Corn flour prepared by dry milling of whole corn kernels was obtained from a local health food store, which had a protein content of 9.5 wt.

Pea protein concentrate having less than 60 wt protein content was obtained from AN Nutrition.

The same method for preparing the emulsion as in Example 1 was used for all the emulsions of Table 8. Cooked and cooled hotdogs were prepared according to the method of Example 2.

The following observations were made during processing, as shown in Table 9:

TABLE 9
Observations during processing

| Food Product | Dough texture | Stuffing properties |
|---|---|---|
| Hotdog made | CPI is very powdery and the | Easy to stuff. |
| with Emulsion | addition at late stage in the | Smooth. |
| A2 | process requires longer mixing. | |
| | Homogenous. | |
| Hotdog made | The Zein protein is very fluffy | Difficult to stuff, |
| with Emulsion | and flaky, causes a very grainy | lots of air trapped |
| C4 | texture. | in the mass |
| Hotdog made | Homogenous mass well | Less difficult to |
| with Emulsion | integrated and smooth. | stuff, little sticky. |
| C5 | | |
| Hotdog made | The best-looking mass, very | Nice and |
| with Emulsion | smooth and soft, elastic and easy | smooth filling. |
| C6 | to stuff | |

### Cooking and Freezing Losses:

FIG. 11 shows the cooking and freezing losses (having the same meaning as in Example 6 above). Replacement of CPI by Zein increased mainly cooking losses and slightly freezing losses.

Replacement of pea protein isolate by pea concentrate reduced cooking yield as well as significantly reduced total yield after freeze/thaw step

Replacement of CPI by corn flour resulted in the highest cooking and freezing losses, which means the lowest yield compared to all other protein combinations under the same processing steps.

### Texture Analyses at Hot Consumption:

FIG. 12 shows the texture analyses at hot consumption (40 °C) of CPI versus zein or corn flour:

Replacement of CPI by zein or corn flour resulted in much softer hot dogs

FIG. 13 shows the texture analyses at hot consumption (40 °C) of pea protein isolate (PPI) versus pea protein concentrate (PPC):

Replacement of pea protein isolate with pea protein concentrate resulted in softer and more elastic hot dogs

### Sensory Appearance:

Replacement of CPI by zein negatively influenced appearance—zein has a more undesirable yellowish/orange colour that is not suitable for hotdogs.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

Although certain example aspects of the invention have been described, the scope of the appended claims is not intended to be limited solely to these examples. The claims are to be construed literally, purposively, and/or to encompass equivalents.

1. A composition comprising:
a pea protein isolate; and
a corn protein isolate.

2. The composition of claim 1, wherein the composition comprises the pea protein and corn protein at a ratio of from 20:80 to 80:20 respectively.

3. The composition of claim 1, wherein the pea protein is an isolate comprising at least 70 wt % of protein; and/or,
wherein the corn protein is an isolate comprising at least 75 wt % of protein.

4. The composition of claim 1, wherein the composition does not comprise substantially any pea flour and/or wherein the composition does not comprise substantially any corn flour and/or wherein the corn protein is not a substantially pure zein protein.

5. The composition of claim 1, wherein the composition is an emulsion and further comprises:
water; and
oil.

6. The composition of claim 5, wherein the corn protein and pea protein combined, the water and the oil are present at a ratio of from 1:1:1 to 1:10:20; and/or,
wherein the composition further comprises one or more of texturising and stabilising systems, sugars, starches, salt, colourants, flavourings and/or any combination thereof.

7. A method of making the composition of claim 1, wherein the method comprises the steps of:
(a) providing a pea protein;
(b) providing water;
(c) combining the pea protein and water to form a hydrated pea protein;
(d) providing a corn protein;
(e) combining the corn protein with the hydrated pea protein to form a mixture;
(f) providing an oil; and
(g) combining the oil with the mixture until an emulsion is formed.

8. The method of claim 7, wherein the steps (a) to (g) are carried out in the order of (a), (b), (c), (d), (e), (f) and then (g); and/or,
wherein the water is at a temperature of from 0.1 to 10 °C; and/or,
wherein the pea protein and water are combined by mixing at a speed of from 100 to 1500 RPM during step (c).

9. The method of claim 7, further comprising the step of combining the pea protein, water, hydrated pea protein and/or corn protein with a texturising and stabilising system, sugar, starch, salt, colourant, flavouring, and/or any combination thereof, optionally,
wherein the pea protein, water, hydrated pea protein and/or corn protein is/are combined with a texturising and stabilising system, sugar, starch, salt, colourant, flavouring, and/or any combination thereof by mixing at a speed of from 100 to 1500 RPM.

10. The method of claim 7, wherein the corn protein and hydrated pea protein are combined by mixing at a speed of from 500 to 4000 RPM during step (e).

11. The method of claim 7, wherein the mixture and oil are combined by mixing at a speed of from 4000 to 6000 RPM during step (g).

12. The method of claim 11, wherein step (g) is carried out at least partially under vacuum; optionally,
wherein step (g) is carried out:
at from 75 to 95% vacuum;
for from 60 to 120 seconds; and/or,
at a speed of from 5000 to 6000 RPM.

13. The method of claim 7, wherein the method further comprises the following step:
(h) cooking the emulsion to form a cooked food product.

14. The method of claim 7, wherein:
the corn protein is provided in an oil; and
step (e) is carried out until an emulsion is formed; and
steps (f) and (g) are not present; optionally,
wherein the corn protein is provided as a dispersion in the oil.

15. A food product obtained, or obtainable, from the method of claim 7.

16. (canceled)

17. (canceled)
